(19) United States
(12) Patent Application Publication
(10) Pub. No.: US 2026/0316692 A1
(43) Pub. Date: Oct. 15, 2026

(54) MOBILE ELECTRONIC DEVICE MOUNTING SYSTEM

(71) Applicant: Bryant Tyler, Fresno, TX (US)

(72) Inventor: Bryant Tyler, Fresno, TX (US)

(21) Appl. No.: 19/175,106

(22) Filed: Apr. 10, 2025

(51) Int. Cl. B60R 11/02; B60R 11/00; F16M 11/08; F16M 11/20; F16M 13/02

(52) U.S. Cl. CPC B60R 11/0241; B60R 11/0217; B60R 11/0252; F16M 11/08; F16M 11/2014; F16M 13/02; B60R 2011/0012; B60R 2011/0071; F16M 2200/024

(57) ABSTRACT

A mobile electronic device mounting system for securing a mobile electronic device in a viewable position in a mass transportation vehicle includes a mounting bracket releasably coupled to a mounting plate on a supporting surface. Aa brace is coupled to the mounting bracket and an extension panel is pivotally coupled to the brace. A distal section of the extension panel is pivotable relative to a proximal section of the extension panel. A device holder is pivotally coupled to the extension panel. A bottom bracket of the device holder has a base wall, a back wall, and a lip. A top bracket is removably couplable to the bottom bracket. The top bracket has a hook to retain a mobile electronic device in the device holder.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to mobile electronic device holders and more particularly pertains to a new mobile electronic device holder for securing a mobile electronic device in a viewable position in a mass transportation vehicle.

### (2) Description of Related Art Including Information Disclosed Under 37 CFR 1.97 and 1.98

The prior art relates to mobile electronic device holders.

### (H) BRIEF SUMMARY OF THE INVENTION

An embodiment of the disclosure meets the needs presented above by generally comprising a mounting bracket releasably coupled to a mounting plate on a supporting surface. Aa brace is coupled to the mounting bracket and an extension panel is pivotally coupled to the brace. A distal section of the extension panel is pivotable relative to a proximal section of the extension panel. A device holder is pivotally coupled to the extension panel. A bottom bracket of the device holder has a base wall, a back wall, and a lip. A top bracket is removably couplable to the bottom bracket. The top bracket has a hook to retain a mobile electronic device in the device holder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a partially exploded top front side perspective view of a mobile electronic device mounting system according to an embodiment of the disclosure.

FIG. 2 is a side view of an embodiment of the disclosure in an extended position.

FIG. 3 is a side view of an embodiment of the disclosure in an unextended position.

FIG. 4 is a top view of an embodiment of the disclosure.

FIG. 5 is a front view of an embodiment of the disclosure.

FIG. 6 is a side view of an embodiment of the disclosure in use.

FIG. 7 is a back view of an embodiment of the disclosure of an alternative mounting plate.

### (J) DETAILED DESCRIPTION OF THE INVENTION

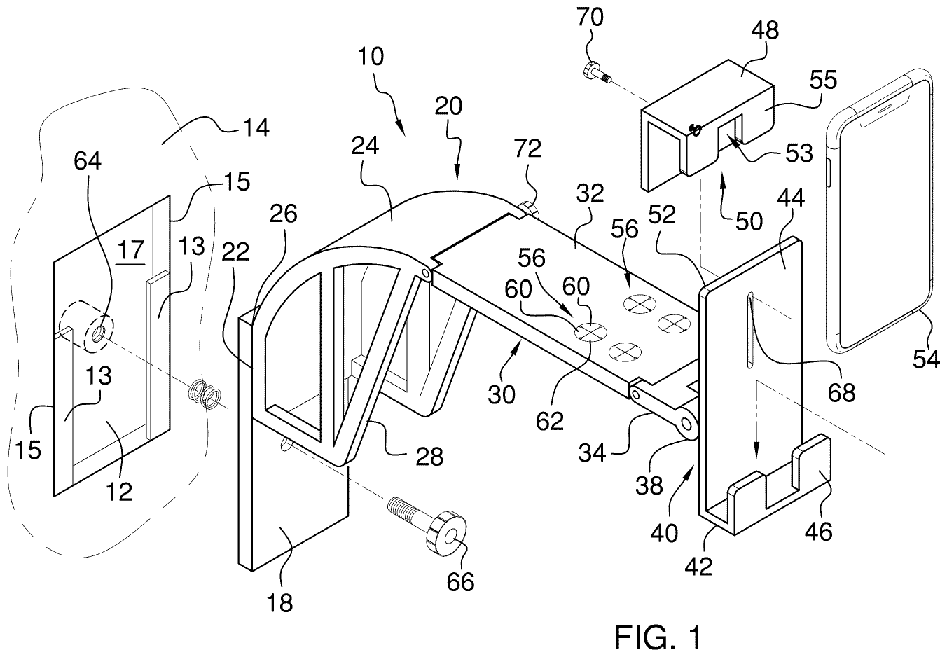

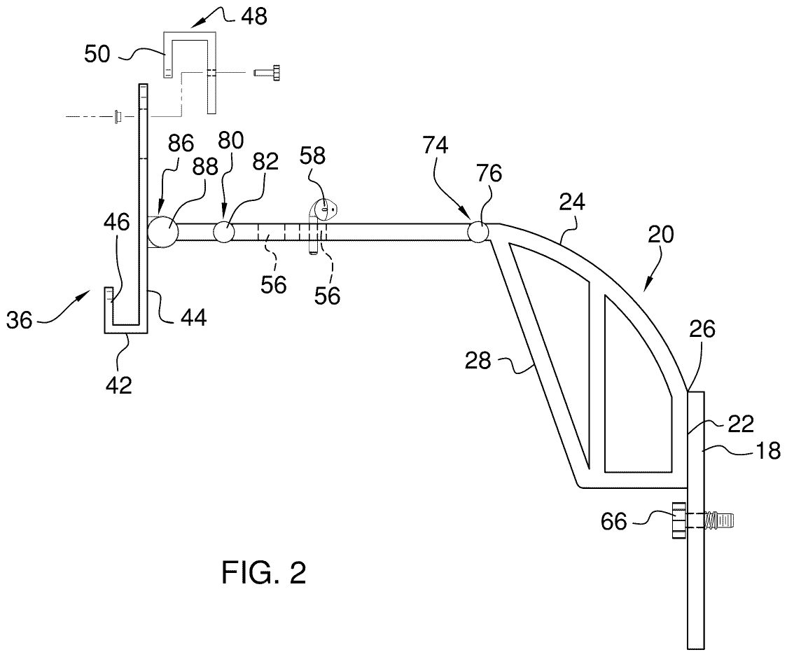

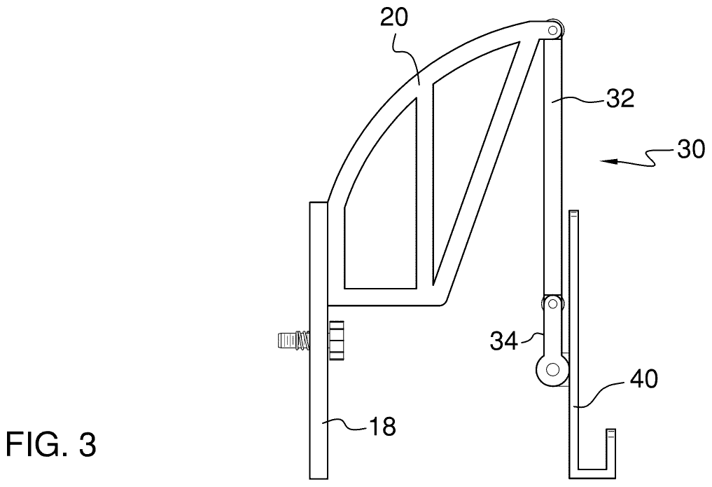

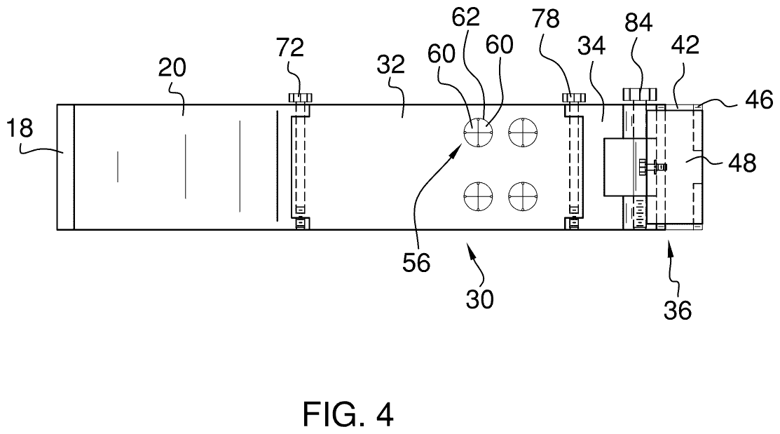

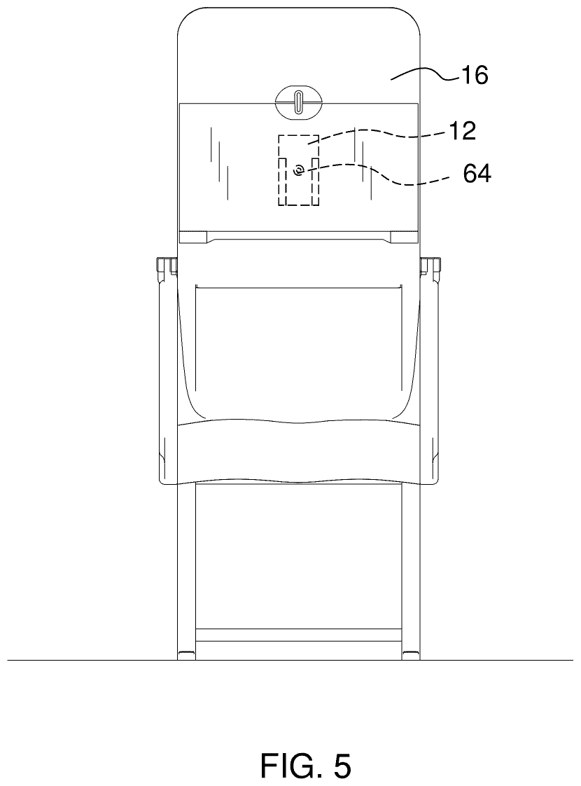

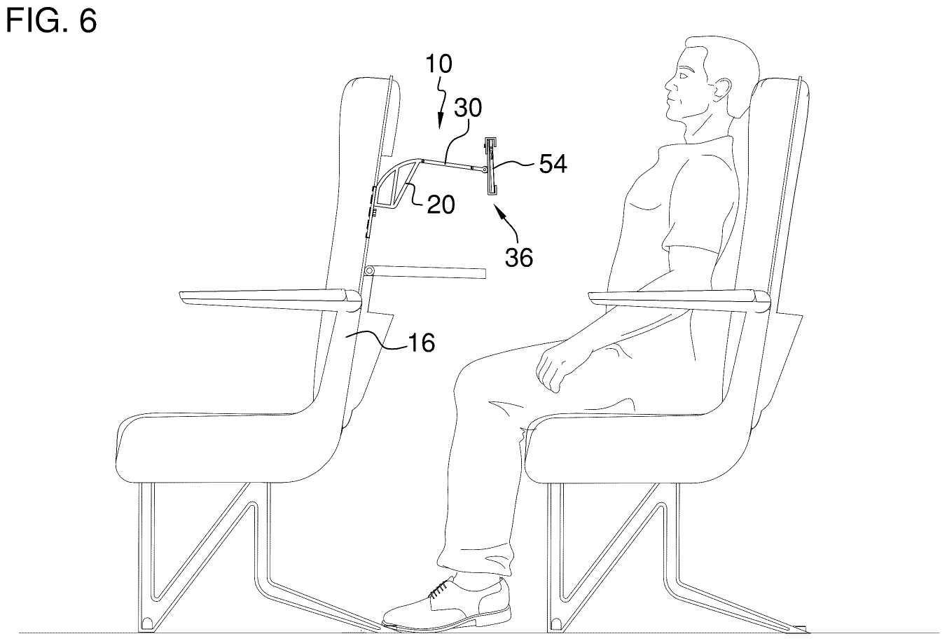

With reference now to the drawings, and in particular to FIGS. 1 through 7 thereof, a new mobile electronic device holder embodying the principles and concepts of an embodiment of the disclosure and generally designated by the reference numeral 10 will be described.

As best illustrated in FIGS. 1 through 7, the mobile electronic device mounting system 10 generally comprises a mounting plate 12 configured for being coupled to a supporting surface 14. The supporting surface 14 may be a back of a vehicle seat 16 such as in an airplane, car, bus, or other vehicle commonly used for transporting people. A mounting bracket 18 is releasably coupled to the mounting plate 12. Flanges 13 extend from lateral sides 15 of the mounting plate 12. The flanges 13 are forwardly spaced from a back 17 of the mounting plate 12. The mounting bracket 18 is insertable into the mounting plate 12 between the flanges 13 and the back 17 of the mounting plate 12. A brace 20 is coupled to the mounting bracket 18. The brace 20 has a back surface 22. The back surface 22 is planar. The brace 20 has an upper surface 24 which is arcuate extending from a top edge 26 of the back surface 22. The brace 20 has a front surface 28. The front surface 28 is planar and angled relative to the back surface 22 such that the front surface 28 extends upwardly and outwardly relative to the back surface 22. An extension panel 30 is pivotally coupled to the brace 20. The extension panel 30 has a proximal section 32 relative to the brace 20 and a distal section 34 relative to the brace 20. The distal section 34 is pivotable relative to the proximal section 32. A device holder 36 is pivotally coupled to a distal end 38 of the extension panel 30 relative to the brace 20.

The device holder 36 includes a bottom bracket 40 having a base wall 42, a back wall 44 extending perpendicularly from the base wall 42, and a lip 46 extending perpendicularly from the base wall 42 spaced from the back wall 44, A top bracket 48 is removably couplable to the bottom bracket 40. The top bracket 48 has a hook 50 extending forwardly from a top 52 of the back wall 44 when the top bracket 48 is coupled to the bottom bracket 40. Thus, the hook 52 is positioned to retain a mobile electronic device 54 in the device holder 36. The hook 52 may include a slot 53 centrally located on a forward flange 55.

Each of a plurality of apertures 56 extends through the extension panel 30 for holding ear buds 58 inserted into the apertures 56. A plurality of flaps 60 is positioned within each of the apertures 56. Each of the flaps 60 is resiliently flexible and extends inwardly from a peripheral edge 62 of the associated aperture 56 such that each of the flaps 60 is configured to facilitate retention of the ear bud 58 in the associated aperture 56.

A threaded hole 64 extends into the mounting plate 12. A mounting screw 66 is insertable through the mounting bracket 18 and threadedly engageable to the threaded hole 64 wherein the mounting bracket 18 is securable to the mounting plate 12. A connection slit 68 extends through the back wall 44 of the lower bracket 40. A connection screw 70 is insertable through the upper bracket 48 and threadedly engageable to a nut inset into the back wall 44 or similar fastener to allow for adjustable connection of the upper bracket 48 to the lower bracket 40.

A brace set screw 72 is extendable through a junction 74 of the brace 20 and the extension panel 30. The brace set screw 72 is aligned with a pivot point 76 between the brace 20 and the extension panel 30 wherein the brace set screw 72 is tightenable to inhibit pivoting of the extension panel 30 relative to the brace 20. An extension panel set screw 78 is extendable through a junction 80 of the proximal section 32 of the extension panel 30 and the distal section 34 of the extension panel 30. The extension panel set screw 78 is aligned with a pivot point 82 between the proximal section 32 of the extension panel 30 and the distal section 34 of the extension panel 30 wherein the extension panel set screw 78 is tightenable to inhibit pivoting of the proximal section 32 of the extension panel 30 relative to the distal section 34 of the extension panel 30. A holder set screw 84 is extendable through a junction 86 of the extension panel 30 and the device holder 36. The holder set screw 84 is aligned with a pivot point 88 between the extension panel 30 and the device holder 36 wherein the holder set screw 84 is tightenable to inhibit pivoting of the extension panel 30 relative to the device holder 36.

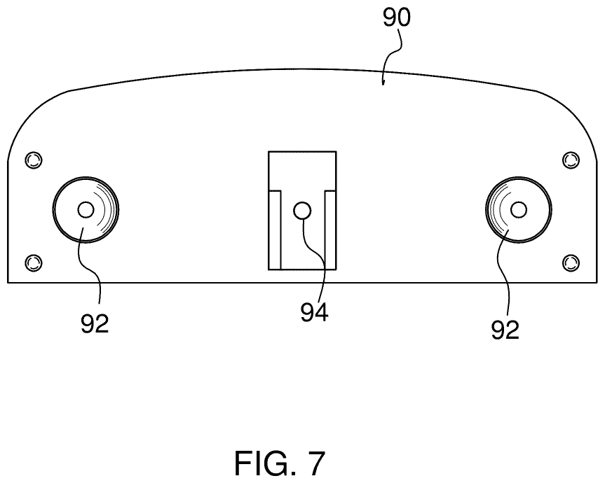

FIG. 7 shows an alternative mount 90 having suction cups 92 and a mount hole 94 for attaching the mounting bracket 18 to the mount 90 using the mounting screw 66. The suction cups 92 allow for releasably mounting the mounting bracket 18, brace 20, extension panel 30, and device holder 36 when there is no mounting plate 12 in the supporting surface 14.

In use, the mounting bracket 18 is secured to the mounting plate 12. The extension panel 30, proximal section 32, and distal section 34 are each pivoted to a desired position and secured in place to position the device holder 36 in a desired position relative to the supporting surface 14. The electronic device 54 is securable in the device holder 36. The electronic device 54 can then be viewed and/or used without having to hold the electronic device 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile electronic device mounting system comprising:
a mounting plate configured for being coupled to a supporting surface;
a mounting bracket releasably coupled to said mounting plate;
a brace coupled to said mounting bracket;
an extension panel pivotally coupled to said brace, said extension panel having a proximal section relative to said brace and a distal section relative to said brace, said distal section being pivotable relative to said proximal section;
a device holder pivotally coupled to a distal end of said extension panel relative to said brace, said device holder including
a bottom bracket having a base wall, a back wall extending perpendicularly from said base wall, and a lip extending perpendicularly from said base wall spaced from said back wall, and
a top bracket removably couplable to said bottom bracket, said top bracket having a hook extending forwardly from a top of said back wall when said top bracket is coupled to said bottom bracket wherein said hook is positioned to retain a mobile electronic device in said device holder.

2. The mobile electronic device mounting system of claim 1, further comprising a plurality of apertures extending through said extension panel wherein said extension panel is configured for holding ear buds inserted into said apertures.

3. The mobile electronic device mounting system of claim 2, further comprising a plurality of flaps, each of said flaps being positioned within an associated one of said apertures, each of said flaps being resiliently flexible and extending inwardly from a peripheral edge of said associated aperture such that each of said flaps is configured to facilitate retention of the ear bud in the associated aperture.

4. The mobile electronic device mounting system of claim 1, further comprising:
said brace having a back surface, said back surface being planar;
said brace having an upper surface, said upper surface being arcuate extending from a top edge of said back surface; and
said brace having a front surface, said front surface being planar and angled relative to said back surface such that said front surface extends upwardly and outwardly relative to said back surface.

5. The mobile electronic device mounting system of claim 1, further comprising:
a threaded hole extending into said mounting plate; and
a mounting screw insertable through said mounting bracket and threadedly engageable to said threaded hole wherein said mounting bracket is securable to said mounting plate.

6. The mobile electronic device mounting system of claim 1, further comprising:
a threaded connection hole extending through said back wall of said lower bracket; and
a connection screw insertable through said upper bracket and threadedly engageable to said threaded connection hole wherein said upper bracket is securable to said lower bracket.

7. The mobile electronic device mounting system of claim 1, further comprising a brace set screw extendable through a junction of said brace and said extension panel, said brace set screw being aligned with a pivot point between said brace and said extension panel wherein said brace set screw is tightenable to inhibit pivoting of said extension panel relative to said brace.

8. The mobile electronic device mounting system of claim 1, further comprising an extension panel set screw extendable through a junction of said proximal section of said extension panel and said distal section of said extension panel, said extension panel set screw being aligned with a pivot point between said proximal section of said extension panel and said distal section of said extension panel wherein said extension panel set screw is tightenable to inhibit pivoting of said proximal section of said extension panel relative to said distal section of said extension panel.

9. The mobile electronic device mounting system of claim 1, further comprising a holder set screw extendable through a junction of said extension panel and said device holder, said holder set screw being aligned with a pivot point between said extension panel and said device holder wherein said holder set screw is tightenable to inhibit pivoting of said extension panel relative to said device holder.

10. A mobile electronic device mounting system comprising:
a mounting plate configured for being coupled to a supporting surface;
a mounting bracket releasably coupled to said mounting plate;
a brace coupled to said mounting bracket, said brace having a back surface, said back surface being planar, said brace having an upper surface, said upper surface being arcuate extending from a top edge of said back surface, said brace having a front surface, said front surface being planar and angled relative to said back surface such that said front surface extends upwardly and outwardly relative to said back surface;
an extension panel pivotally coupled to said brace, said extension panel having a proximal section relative to said brace and a distal section relative to said brace, said distal section being pivotable relative to said proximal section;
a device holder pivotally coupled to a distal end of said extension panel relative to said brace, said device holder including
a bottom bracket having a base wall, a back wall extending perpendicularly from said base wall, and a lip extending perpendicularly from said base wall spaced from said back wall, and
a top bracket removably couplable to said bottom bracket, said top bracket having a hook extending forwardly from a top of said back wall when said top bracket is coupled to said bottom bracket wherein said hook is positioned to retain a mobile electronic device in said device holder;
a plurality of apertures extending through said extension panel wherein said extension panel is configured for holding ear buds inserted into said apertures;
a plurality of flaps, each of said flaps being positioned within an associated one of said apertures, each of said flaps being resiliently flexible and extending inwardly from a peripheral edge of said associated aperture such that each of said flaps is configured to facilitate retention of the ear bud in the associated aperture;
a threaded hole extending into said mounting plate;
a mounting screw insertable through said mounting bracket and threadedly engageable to said threaded hole wherein said mounting bracket is securable to said mounting plate;
a threaded connection hole extending through said back wall of said lower bracket;
a connection screw insertable through said upper bracket and threadedly engageable to said threaded connection hole wherein said upper bracket is securable to said lower bracket;
a brace set screw extendable through a junction of said brace and said extension panel, said brace set screw being aligned with a pivot point between said brace and said extension panel wherein said brace set screw is tightenable to inhibit pivoting of said extension panel relative to said brace;
an extension panel set screw extendable through a junction of said proximal section of said extension panel and said distal section of said extension panel, said extension panel set screw being aligned with a pivot point between said proximal section of said extension panel and said distal section of said extension panel wherein said extension panel set screw is tightenable to inhibit pivoting of said proximal section of said extension panel relative to said distal section of said extension panel;
a holder set screw extendable through a junction of said extension panel and said device holder, said holder set screw being aligned with a pivot point between said extension panel and said device holder wherein said holder set screw is tightenable to inhibit pivoting of said extension panel relative to said device holder.
